(19) United States
(12) Patent Application Publication
(10) Pub. No.: US 2009/0200249 A1
(43) Pub. Date: Aug. 13, 2009

(54) DESALINATION SYSTEM AND PRESSURE STORAGE SYSTEMS THEREFOR

(76) Inventor: Erez Zimhoni, Kafar Hes (IL)

Correspondence Address: The Law Office of Michael E. Kondoudis, PC, 888 16th Street, N.W., Suite 800, Washington, DC, 20006, US

(21) Appl. No.: 12/351,849

(22) Filed: Jan. 11, 2009

Related U.S. Application Data
(60) Provisional application No. 61/063,884, filed on Feb. 8, 2008.

(51) Int. Cl. C02F 9/00; C02F 103/08

(52) U.S. Cl. 210/808; 210/416.1; 210/195.1

(57) ABSTRACT

The disclosure provides a desalination system comprising an energy source, a pump, an accumulator and at least one desalination unit, the pump being coupled to the energy source to provide a pressurized feed of water downstream towards the at least one desalination unit, wherein the feed of water from the pump passes through the accumulator before reaching the at least one desalination unit.

### BACKGROUND

The present disclosure relates to a water desalination system and to systems that store pressurized fluid that may be used utilized in the desalination system.

In a water desalination system, a pump is normally used to feed water to the system. In reverse osmosis (RO) desalination systems, for example, this water supply is fed to membranes that in turn remove ionic, organic and/or suspended solids from the water supply.

### SUMMARY

The following embodiment and aspects thereof are described and illustrated in conjunction with systems, tools and methods which are meant to be exemplary and illustrative, not limiting in scope.

In an embodiment is provided a desalination system comprising an energy source, a pump, an accumulator and at least one desalination unit, the pump being coupled to the energy source to provide a pressurized feed of water downstream towards the at least one desalination unit, wherein the feed of water from the pump passes through the accumulator before reaching the at least one desalination unit.

In an embodiment, the accumulator is adapted to store at least part of the feed of water under pressure.

In an embodiment, the energy source is a renewable or clean energy source.

In an embodiment, the energy source is a tank comprising pressurized fluid, and wherein said pressurized fluid is adapted to power the pump.

In an embodiment, the tank is a replaceable tank, said tank being adapted to receive its fluid at a location other than the location of the system.

In an embodiment, the energy source is a closed system, said closed system comprising a means urging fluid via a condenser and an evaporator, wherein the pump of the desalination system is located between the condenser and the evaporator for utilizing the flow of fluid in the closed system to pump water into the desalination system.

In an embodiment is also provided a method for the desalination of water comprising the steps of: providing a desalination system comprising a pump, an accumulator and at least one desalination unit, the pump forming a feed of water being urged downstream towards the at least one desalination unit via the accumulator, wherein at least part of the water is accumulated in the accumulator.

In an embodiment, the accumulator comprises first and second sections, the first section holding fluid and the second section being adapted to receive the feed of water.

In an embodiment is provided a storage system is provided, said storage system comprising an energy source, a compressor and a tank, the compressor being powered by the energy source to compress fluid into the tank, wherein the tank is adapted to provide energy to the pump of the desalination system.

In an embodiment is provided a storage system is provided, said storage system comprising an energy source, a compressor and a tank, the compressor being powered by the energy source to compress fluid into the tank, wherein the tank is adapted to provide pressurized fluid to the first section of the accumulator.

In an embodiment is provided the storage system is located at a location other than the desalination system, and wherein the energy source of the storage system is a renewable or clean energy source.

In an embodiment is provided is also provided a system comprising an energy source, a compressor a first tank, a second tank and a power utility; the energy source providing energy to the compressor to thereby urge fluid to flow downstream in a closed loop through the first and second tanks and back to the compressor, wherein the system comprises a condenser located upstream of the first tank and an evaporator located upstream of the second tank, and wherein the power utility is located downstream of the first tank and utilizes the flow of fluid exiting the first tank to provide an output power.

In an embodiment, the fluid is a refrigerant fluid.

In addition to the exemplary aspects and embodiment described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 shows a water desalination system in accordance with an embodiment of the present disclosure;

FIG. 2 shows a storage system in accordance with an aspect of the present disclosure; and

FIG. 3 shows a closed loop storage system in accordance with another aspect of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

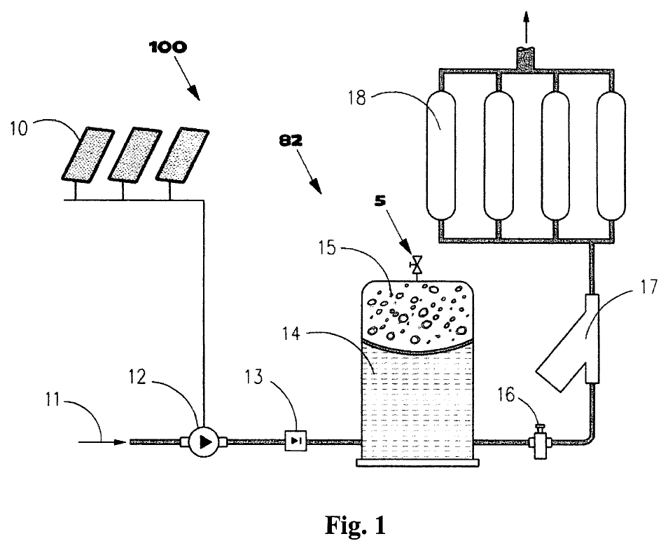

Attention is drawn to FIG. 1. A desalination system 100 has an energy source 10, a pump 12, a pressure storage system 82 in the form of an accumulator and desalination units 18. The energy source 10 provides energy to the pump 12 that in turn pumps water 11 downstream towards the desalination units 18. This water, which is optionally salt water, passes through the accumulator where it is optionally accumulated under pressure.

The accumulator is optionally of the type having a first section 15 that holds fluid and an adjacent second section 14 that is adapted to receive the incoming water. It should be noted that directional terms appearing throughout the specification and claims, e.g. “downstream”, “upstream” etc., (and derivatives thereof) are for illustrative purposes only, and are not intended to limit the scope of the appended claims.

The water on its way to the accumulator passes optionally through a non return valve 13 of the system 100 before entering the second section 14 of the accumulator. A regulating device 16 of the system 100, located downstream of the accumulator, regulates the flow of water out of the accumulator and downstream towards the desalination units 18. A filter 17 of the system 100, located downstream of the regulator 16, filters the water before it enters the desalination units 18.

The energy source 10 is optionally a renewable/clean energy source such as for example a wind turbine or a solar panel. The water pumped into the accumulator enters section 14, fills it up and then starts to expand section 14 into the volume previously occupied by section 15. The fluid stored in section 15 is compressed and thereby imposes pressure upon the water stored in section 14 of the accumulator.

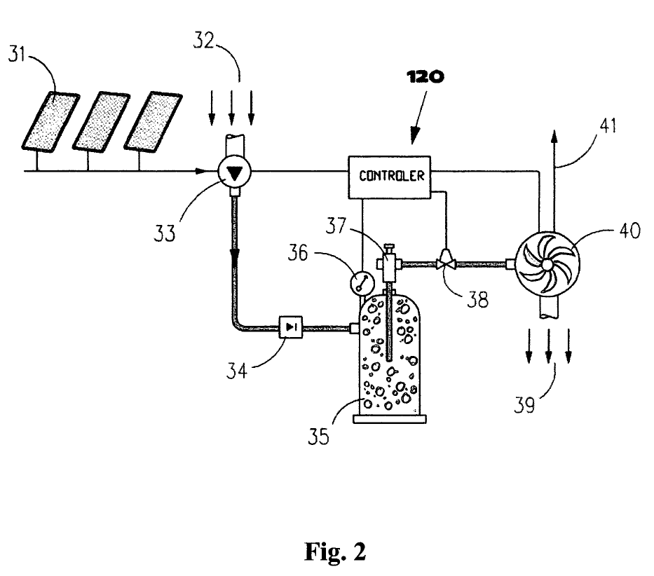

Attention is drawn to FIG. 2. In an aspect of the disclosure is provided a fluid storage system 120 that has an energy source 31 that powers a compressor 33 that in turn compresses fluid 32 downstream via non return valve 34 into a fluid tank 35. Optionally, the fluid in system 120 is air.

In an embodiment, a controller is coupled to a pressure gauge 36 on tank 35 and affects the exit of fluid downstream from tank 35 by controlling the opening and/or closing of valve 38. At a given fluid pressure in tank 35, the controller may open valve 38 to allow fluid to exit tank 35 via regulator 37. This fluid for example may flow through generator 40 and out 39 of the system to thereby optionally produce output energy 41.

It is noted that system 120 may be located at a location where the source powering the energy source 31 is available and/or optimal. For example, the source may be wind and energy source 31 may be a wind turbine. In this example system 120 may be located at a location where wind is optimal.

In an embodiment of the disclosure, the fluid compressed into tank 35 may be stored in tank 35 for later use at another location where for example the desalination system 100 shown in FIG. 1 is located. System 100 may be for example located adjacent a water source and the system 120 may be for example located on a mountain top where wind is optimal.

In one example, the fluid stored under pressure in tank 35 may be urged into section 15 of the accumulator shown in FIG. 1 via valve 5 of the accumulator. In another example, tank 35 may replace energy source 10 of system 100 in FIG. 1 by providing an input of pressurized fluid that powers pump 12 of system 100 to pump water downstream.

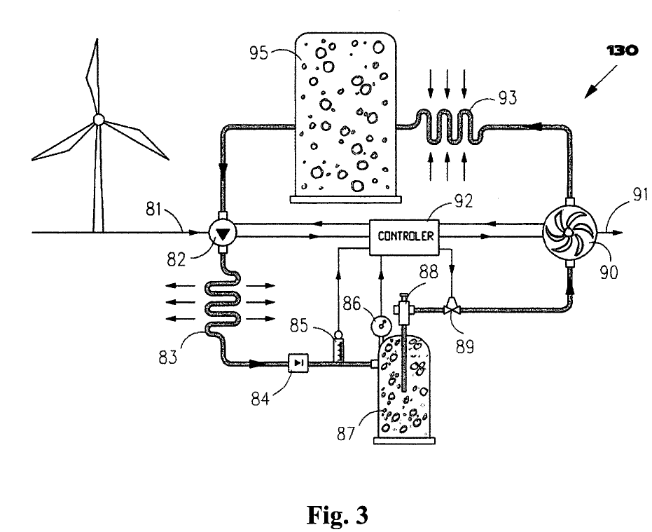

Attention is drawn to FIG. 3. In an aspect of the disclosure is provided a closed loop storage system 130. System 130 has an energy source 81 that is optionally a renewable/clean energy source. The energy source 81 is coupled to a pump 82 that is located on the system. Downstream of the pump 82, in a counter clock wise direction, are provided in sequence the following main elements which are in fluid communication one with the other. A condenser 83, a non return valve 84, a first tank 87, a regulating device 88, a power utility 90, an evaporator 93 and a second tank 95. Fluid passing via pump 82 flows passed the above mentioned elements to return back to flow via pump 82 to form a closed loop. Optionally, the fluid in system 130 is a refrigerant fluid.

Energy provided by energy source 81 powers pump 82 to pump fluid downstream. As the fluid passes via condenser 83 it cools down, optionally condensing from gas into liquid, and enters first tank 87 via non return valve 84. A controller of the system 130 is coupled to: pump 82, to a thermometer 85, to a pressure gauge 86, to a control valve 89 and to power utility 90. Thermometer 85 is located downstream of first tank 87 and measures the temperature of the fluid flowing therein and pressure gauge 86 is located on first tank 87 and measures the pressure of fluid therein.

The controller controls the flow of fluid out of first tank 87 by the opening and/or closing of control valve 89. By opening valve 89, fluid flows out of first tank 87 via regulating device 88 to flow passed power utility 90 to produce an output power 91. As the fluid flows onwards downstream from power utility 90 it passes via evaporator 93, optionally vaporizing from liquid into gas, and into second tank 95. From there the fluid continues to flow back to pump 82 and so on.

It is noted that the condenser and its associated first tank and the evaporator and its associated second tank form a carnot type cycle in system 130 that improves the efficiency of system 130 and the flow rate of fluid flowing therein that provides work.

In an embodiment, system 130 may be coupled to the desalination system 100 shown in FIG. 1 to optionally replace energy source 10 of system 100. In this example, power utility 90 is pump 12 of system 100 and the output power 91 is the water being pumped downstream into system 100.

As already mentioned, the energy sources described herein above are optionally renewable/clean energy sources such as for example wind turbines or solar panels. Such energy sources are adapted to provide energy as long as the renewable/clean sources they utilize (e.g. wind, sun . . . ) are available. The ability of such energy sources to store their energy optionally in the form of pressure enables systems such as the desalination system 100 to utilize such a renewable/clean energy for duration of time that is longer than the time that the source (wind, sun) is available.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb. Although the present embodiment has been described to a certain degree of particularity, it should be understood that various alterations and modifications could be made without departing from the scope of the disclosure as hereinafter claimed.

1. A desalination system comprising an energy source, a pump, an accumulator and at least one desalination unit,
the pump being coupled to the energy source to provide a pressurized feed of water downstream towards the at least one desalination unit, wherein
the feed of water from the pump passes through the accumulator before reaching the at least one desalination unit.

2. The desalination system according to claim 1, wherein the accumulator is adapted to store at least part of the feed of water under pressure.

3. The desalination system according to claim 1, wherein the energy source is a renewable or clean energy source.

4. The desalination system according to claim 1, wherein the energy source is a tank comprising pressurized fluid, and wherein said pressurized fluid is adapted to power the pump.

5. The desalination system according to claim 4, wherein the tank is a replaceable tank, said tank being adapted to receive its fluid at a location other than the location of the system.

6. The desalination system according to claim 1, wherein the energy source is a closed loop system, said closed system comprising a means urging fluid via a condenser and an evaporator, wherein the pump of the desalination system is located between the condenser and the evaporator for utilizing the flow of fluid in the closed loop system to pump water into the desalination system.

7. A method for the desalination of water comprising the steps of:
providing a desalination system comprising a pump, an accumulator and at least one desalination unit,
the pump forming a feed of water being urged downstream towards the at least one desalination unit via the accumulator, wherein
at least part of the water is accumulated in the accumulator.

8. The method according to claim 7, wherein the accumulator comprises first and second sections, the first section holding fluid and the second section being adapted to receive the feed of water.

9. The method according to claim 7, wherein a storage system is provided, said storage system comprising an energy source, a compressor and a tank, the compressor being powered by the energy source to compress fluid into the tank, wherein the tank is adapted to provide energy to the pump of the desalination system.

10. The method according to claim 8, wherein a storage system is provided, said storage system comprising an energy source, a compressor and a tank, the compressor being powered by the energy source to compress fluid into the tank, wherein the tank is adapted to provide pressurized fluid to the first section of the accumulator.

11. The method according to claim 9, wherein the storage system is located at a location other than the desalination system, and wherein the energy source of the storage system is a renewable or clean energy source.

12. A system comprising an energy source, a compressor a first tank, a second tank and a power utility; the energy source providing energy to the compressor to thereby urge fluid to flow downstream in a closed loop through the first and second tanks and back to the compressor, wherein the system comprises a condenser located upstream of the first tank and an evaporator located upstream of the second tank, and wherein the power utility is located downstream of the first tank and upstream of the evaporator to thereby utilize the flow of fluid exiting the first tank to provide an output power.

13. The system according to claim 12, wherein the fluid is a refrigerant fluid.

14. The method according to claim 10, wherein the storage system is located at a location other than the desalination system, and wherein the energy source of the storage system is a renewable or clean energy source.
